(19) United States
(12) Patent Application Publication
(10) Pub. No.: US 2002/0122610 A1
(43) Pub. Date: Sep. 5, 2002

(54) Dynamic pressure-type thrust bearing unit and manufacturing method thereof

(76) Inventor: Masahiro Shiraishi, Ozu-shi (JP)

Correspondence Address: PARKHURST & WENDEL, L.L.P., 1421 PRINCE STREET, SUITE 210, ALEXANDRIA, VA, 22314-2805, US

(21) Appl. No.: 10/070,552

(22) PCT Filed: Jul. 18, 2001
(86) PCT No.: PCT/JP01/06231

(30) Foreign Application Priority Data
Jul. 21, 2000 (JP) 2000-219909

(51) Int. Cl. F16C 32/06

(52) U.S. Cl. 384/123

(57) ABSTRACT

The present invention provides a dynamic pressure-type thrust bearing unit which is excellent in abrasion resistance and also has accurate dynamic pressure-generating grooves through easy manufacturing processes. According to a method for manufacturing a dynamic pressure-type thrust bearing unit of the present invention, dynamic pressure-generating grooves (2) are formed on a surface (1a) of a thrust plate (1). The dynamic pressure-generating grooves (2) are formed by pressing with a pattern which produces a width ratio of approximately 1:1 between groove portions (12) and non-groove portions (13) in the direction of arrangement of the adjacent dynamic pressure-generating grooves (2) [in the direction of arrow A].

### TECHNICAL FIELD

The present invention relates to a dynamic pressure-type thrust bearing unit and a manufacturing method thereof.

### BACKGROUND ART

Conventionally, a spindle motor using a dynamic pressure-type liquid bearing unit has been used in an information apparatus such as a magnetic disk drive unit.

A dynamic pressure-type thrust bearing unit which constructs a dynamic pressure-type liquid bearing unit comprises, as shown in FIG. 10, a shaft body 11 having a thrust flange 7 provided on the front end portion thereof and a thrust plate 1 provided on the side of a sleeve 10 which is rotatably supported on this shaft body 11, and the thrust plate 1 and the thrust flange 7 are opposed to each other, and a fluid is filled between the shaft body 11 and the sleeve 10 and between the thrust flange 7 and the thrust plate 1.

On at least one surface of the opposed surfaces of the thrust flange 7 and the thrust plate 1, dynamic pressure-generating grooves (hereinafter, referred to as “dynamic pressure grooves”) are formed. These dynamic pressure grooves are of a shape where a plurality of V-shaped or U-shaped grooves are continuous, which shape is generally called a herringbone.

In the thrust bearing unit constructed as above, a rotating body composed of the thrust plate 1 and the sleeve 10 relatively rotates with respect to a stationary shaft composed of the thrust flange 7 and the shaft body 11. Thus, dynamic pressure is generated due to rotation of the rotating body and the rotating body floats up. The dynamic pressure to be generated, that is, the floating-up amount changes depending on the angle of the V-shaped or U-shaped grooves of the dynamic pressure grooves, the groove width, the number of grooves, the length, depth, flatness and the like, and also fluctuations occur due to the relative number of rotations between the rotating body and stationary shaft and the gap, and furthermore, viscosity of the fluid filled between the rotating body and the stationary shaft.

In a case where the thrust plate 1 and the thrust flange 7 are made of, for example, a comparatively soft metal such as brass, a resin material or the like, the above dynamic pressure grooves are formed by press working. However, such a thrust plate 1 and thrust flange 7 are weak in abrasion resistance and have a problem such that powder due to abrasion and the like occurs during use and their life cycles become short.

Therefore, in order to increase the abrasion resistance, it has been demanded to form the thrust plate 1 and thrust flange 7 by a metal such as stainless steel and a Ni-plated member, which are harder than brass and a resin material.

However, press working is carried out for forming a pattern having a predetermined shape by causing material for forming a processing surface to flow, therefore, flow of material is not smoothly carried out for the processing surface made of such a hard material as above. Therefore, as shown in FIG. 11, it is difficult to make groove portions 12 and non-groove portions 13 along the direction of arrangement of dynamic pressure grooves 2 (the direction of arrow A) having a uniform width, and an insufficiency in groove depth, unevenness in depth, and furthermore, poor flatness and the like occur, therefore accurate dynamic pressure grooves 2 cannot be obtained.

Therefore, when forming dynamic pressure grooves 2 on a hard metallic surface, an etching method, a shot blasting method, a plating method and the like are carried out.

However, in each of these methods, a number of processes including a cleaning process, a masking process, an etching (a shot blasting, or plating) process, and a neutralizing (coating-stripping) process, and furthermore, a cleaning process become necessary, therefore a problem exists such that operations become complicated, resulting in high costs.

### DISCLOSURE OF THE INVENTION

It is an object of the present invention to solve the above-described problems and provide a dynamic pressure-type thrust bearing unit and a manufacturing method thereof which is excellent in abrasion resistance, has accurate dynamic pressure grooves, and in addition, manufacturing processes therefor are easy.

A method for manufacturing a dynamic pressure-type thrust bearing unit according to a first aspect of the present invention is a method for manufacturing a dynamic pressure-type thrust bearing unit in which dynamic pressure-generating grooves are formed on at least one surface of opposed surfaces of a thrust flange and a thrust plate, the thrust flange being provided on a front end portion of a shaft body, and the thrust plate being provided, in an opposed relation to the thrust flange, at a side of a rotating body rotatably supported on the shaft body, wherein a groove-cutting surface for forming thereon the dynamic pressure-generating grooves is pressed with a pattern which produces a width ratio of approximately 1:1 between groove portions and non-groove portions in the direction of arrangement of the adjacent dynamic pressure-generating grooves.

According to this construction, the groove portions and non-groove portions coincide in volume and a plastic deformation of the groove-cutting surface for forming thereon the dynamic pressure-generating grooves can be carried out without difficulty, therefore accurate dynamic pressure generating grooves can be easily formed.

A method for manufacturing a dynamic pressure-type thrust bearing unit according to a second aspect of the present invention is characterized in that, in the first aspect, a metal for forming the groove-cutting surface for forming thereon the dynamic pressure-generating grooves is caused to flow from a central portion toward an outer peripheral portion of the surface, and pressed so that an outside diameter of the pattern becomes approximately the same size as that of the groove-cutting surface for forming thereon the dynamic pressure-generating grooves.

According to this construction, more accurate dynamic pressure generating grooves can be formed.

A method for manufacturing a dynamic pressure-type thrust bearing unit according to a third aspect of the present invention is characterized in that, in the first aspect, dynamic pressure-generating grooves are pressed to an outer peripheral portion of a straight hole or a stepped hole formed in the central portion of the groove-cutting surface for forming thereon the dynamic pressure-generating grooves.

According to this construction, the metal for forming the groove-cutting surface flows not only towards the outer peripheral portion but also towards the inner peripheral portion, therefore, even more accurate dynamic pressure grooves can be realized.

A method for manufacturing a dynamic pressure-type thrust bearing unit according to a fourth aspect of the present invention is characterized in that, in the first aspect, dynamic pressure-generating grooves are simultaneously pressed to both surfaces of the thrust flange.

According to this construction, restoration of plastic deformation of the metal which is caused, by pressing from both sides, to flow to the outer and inner peripheral portions can be made even smaller.

A method for manufacturing a dynamic pressure-type thrust bearing unit according to a fifth aspect of the present invention is characterized in that, in the fourth aspect, phases of the dynamic pressure-generating grooves to be formed on one surface and the dynamic pressure-generating grooves to be formed on the other surface are adjusted to correspond to each other at the time of pressing.

According to this construction, fluidity of the material forming the groove-cutting surface for forming thereon the dynamic pressure-generating grooves can be further improved.

A method for manufacturing a dynamic pressure-type thrust bearing unit according to a sixth aspect of the present invention is characterized in that, in the first aspect, a shaft body-receiving surface of the thrust flange is pressed with a pattern which forms concave portions and convex portions arranged radially or concentrically, and produces the width ratio of approximately 1:1 between the concave portions and the convex portions, thereby improving flatness of the shaft body-receiving surface.

According to this construction, flatness of the shaft body-receiving surface is improved, thereby accuracy of attachment of the shaft body to the thrust flange can be improved.

A method for manufacturing a dynamic pressure-type thrust bearing unit according to a seventh aspect of the present invention is characterized in that, in the first aspect, after the dynamic pressure-generating grooves have been formed, the thrust flange or the thrust plate is processed with flat-pressing.

According to this construction, deterioration in flatness caused by compositional unevenness of the material and differences in accuracy of machinery tools in use can be improved.

A dynamic pressure-type thrust bearing unit according to an eighth aspect of the present invention is characterized in that, dynamic pressure-generating grooves are formed on at least one surface of opposed surfaces of a thrust flange and a thrust plate, the thrust flange being provided on a front end portion of a shaft body, and the thrust plate being provided, in an opposed relation to the thrust flange, at a side of a rotating body, wherein the dynamic pressure-generating grooves are formed to produce a width ratio of approximately 1:1 between groove portions and non-groove portions in the direction of arrangement of the adjacent dynamic pressure-generating grooves.

According to this construction, a dynamic pressure-type thrust bearing unit which is excellent in abrasion resistance and also has accurate dynamic pressure-generating grooves can be realized.

A method for manufacturing a dynamic pressure-type thrust bearing unit according to a ninth aspect of the present invention is characterized in that, in any of the first through seventh aspects, the groove-cutting surface for forming thereon the dynamic pressure-generating grooves, which is subjected to pressing, has a hardness of 180 through 340 as expressed in Vickers hardness.

According to this construction, a dynamic pressure-type thrust bearing unit which is excellent in abrasion resistance can be easily realized.

### BRIEF DESCRIPTION OF DRAWINGS

FIG. 1 shows a side view and a plan view of a thrust plate according to Embodiment 1 of the present invention;

FIG. 2 shows an enlarged view of a main part of dynamic pressure grooves in FIG. 1 and enlarged sections of the grooves along a direction of arrow A;

FIG. 3 shows an enlarged section of a dynamic pressure grooves-formed surface of the thrust plate in FIG. 1;

FIG. 4 shows an enlarged section of a coining tool according to the same embodiment;

FIG. 5 shows schematic views for explaining various types of flat surface punches according to the same embodiment;

FIG. 6 shows side views and plan views of a thrust flange according to Embodiment 2 of the present embodiment;

FIG. 7 shows side views and plan views of a thrust flange according to Embodiment 3 of the present invention;

FIG. 8 shows schematic views for explaining press working on the thrust flange according to the same embodiment;

FIG. 9 shows schematic views for explaining press working on a bearing body-receiving surface of the thrust flange according to the same embodiment;

FIG. 10 shows a longitudinal section of a prior-art dynamic pressure-type thrust bearing unit; and

FIG. 11 shows a schematic view of prior-art dynamic pressure grooves.

### BEST MODE FOR CARRYING OUT THE INVENTION

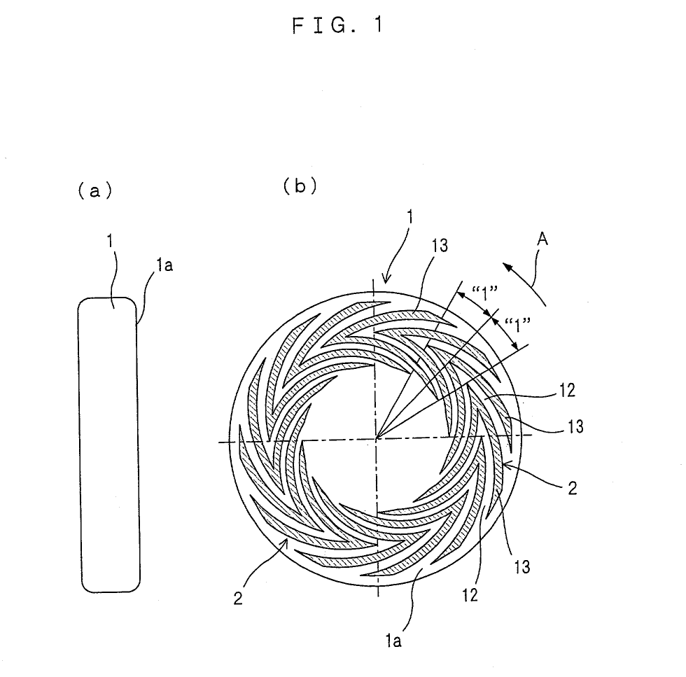

Hereinafter, embodiments of the present invention will be described in detail by means of FIG. 1 through FIG. 9.

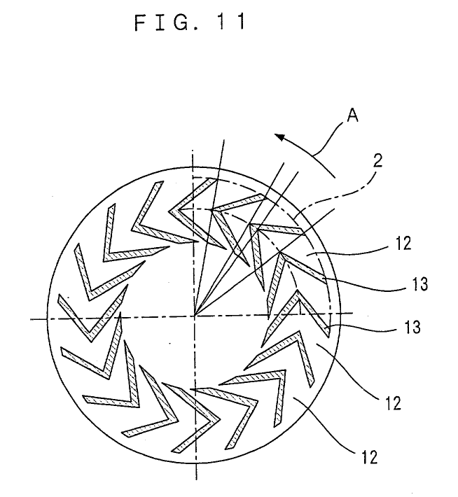

Herein, identical symbols will be used for components forming constructions similar to those of FIG. 10 and FIG. 11, which show the above prior-art, and a detailed description thereof will be omitted.

(Embodiment 1)

FIG. 1 through FIG. 5 show Embodiment 1 of the present invention.

In Embodiment 1, on the dynamic pressure grooves-forming surface having a hard metallic surface such as stainless steel, dynamic pressure grooves 2 are formed so that the width of groove portions 12 to non-groove portions 13 along the direction of arrangement of the adjacent dynamic pressure grooves 2 becomes approximately 1:1, which is an aspect different from the above prior art.

Hereinafter, as shown in FIG. 1(a) and FIG. 1(b), a description will be given of a dynamic pressure grooves 2 formed on a surface 1a of a thrust plate 1 of a dynamic pressure-type thrust bearing unit, which is constructed similarly to FIG. 10, by way of example.

On one surface 1a of the disk-like thrust plate 1 made of stainless steel, the plurality of V-shaped herringbone dynamic pressure grooves 2 which are arranged along the circumferential direction of the thrust plate 1 and are bent in the outer circumferential direction are formed. The groove angle of groove portions 12 (the angle at which a V-letter is open) is 0 through 20°, the groove width is 0.1 through 0.5 mm, the groove depth is 3 through 18 μm, and the number of grooves is 8 through 24.

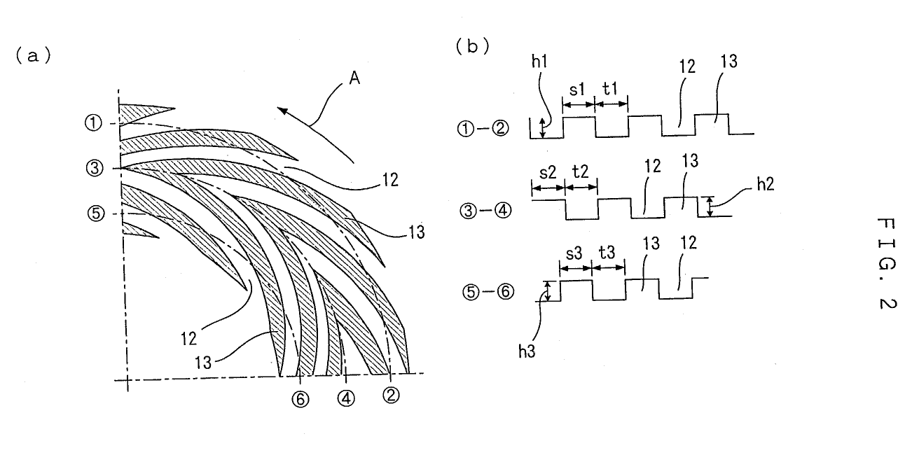

The dynamic pressure grooves 2 are arranged, with the V-shaped front ends of the groove portions 12 and the non-groove portions 13 oriented in a counterclockwise direction and lined up so that a line connecting these front ends becomes circular, in an overlapping manner in the circumferential direction. In addition, the groove portions 12 and the non-groove portions 13 have undergone, as shown in FIG. 1(b), FIG. 2(a), and FIG. 2(b), press working with a pattern whereby the width of the groove portions 12 to the non-groove portions 13 becomes approximately 1:1 along the direction of arrangement of the adjacent dynamic pressure grooves 2 [the direction of arrow A].

For example, FIG. 2(b) shows sections along line [1]-[2], line [3]-[4], and line [5]-[6] of FIG. 2(a), wherein the widths t1 through t3 of the groove portions 12 to the widths S1 through S3 of the non-groove portions 13 are, respectively, formed so as to become approximately 1:1.

After press working is applied as such to the surface 1aof the thrust plate 1 so as to produce a pattern whereby the widths t1 through t3 of the groove portions 12 to the widths S1 through S3 of the non-groove portions 13, which are adjacent to each other, become approximately 1:1, the material flows and a plastic deformation occurs, whereby the groove depths h1 through h3 of the groove portions 12 become approximately the same depth.

Accordingly, even with the thrust plate 1 made of a hard metallic surface such as stainless steel, the accurate dynamic pressure grooves 2 can be easily formed by press working. Therefore, the thrust plate 1 excellent in corrosion resistance, resistance to chemical change, and abrasion resistance can be obtained, thus a low-cost and highly accurate thrust bearing unit can be realized.

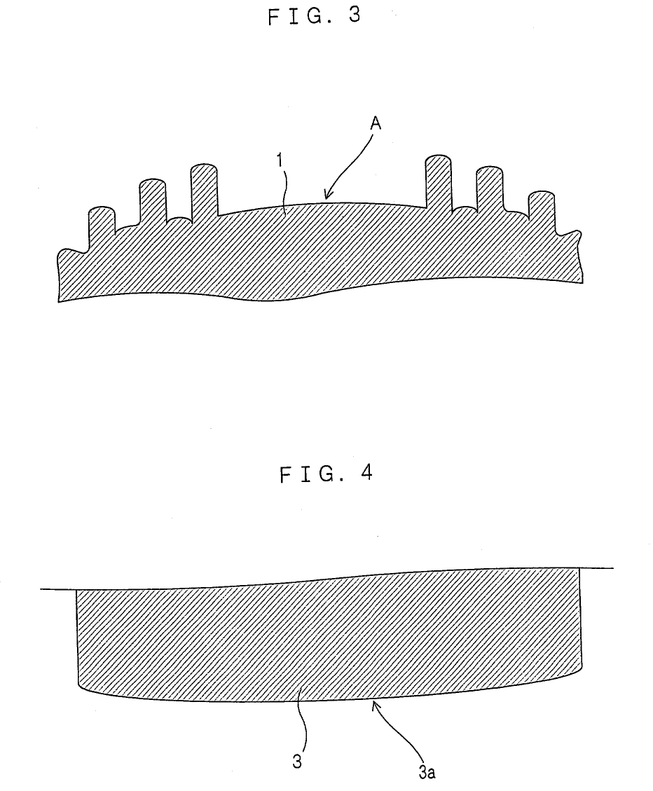

However, on the disk-like thrust plate 1 as described above, the material flows toward the outer circumferential direction due to press working. Therefore, depending on the composition of the material for forming the thrust plate 1, in some cases, a shape where the central portion swells up as arrow A shown in FIG. 3 is formed and flatness of the thrust plate 1 slightly deteriorates.

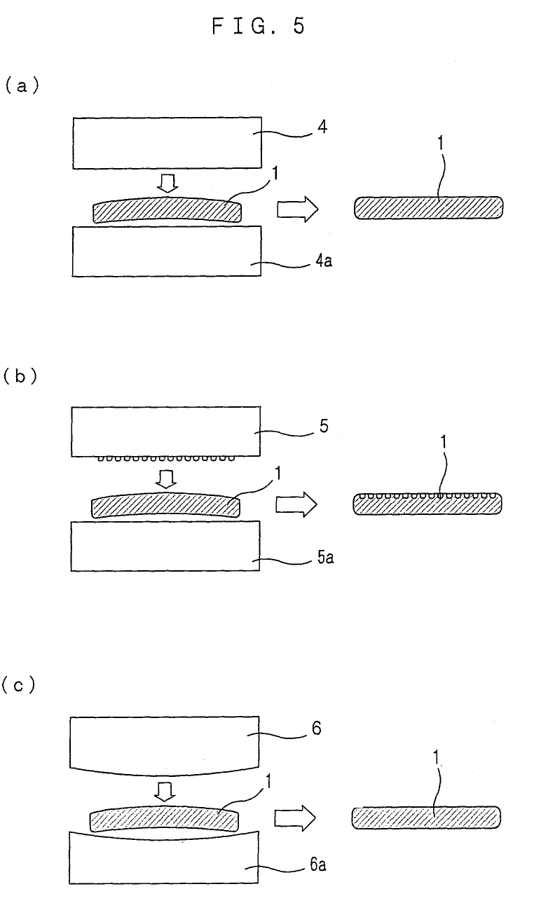

In such a case, as shown in FIG. 4, to some extent on the outer circumference of a coining tool 3 for applying press working, a pattern is formed so that the outside diameter of the dynamic pressure grooves 2 becomes approximately equal to the outside diameter of the thrust plate 1, the shape of the front end of the coining tool 3 is formed in a convex shape 3a where the central portion swells up, and during pressing, the material for forming the thrust plate 1 is actively pushed out to the outer circumferential portion for plastic deformation, thus the flatness of the thrust plate 1 can be improved.

In addition, in a case where deterioration in flatness occurs on the thrust plate 1 due to compositional unevenness of the material constructing the thrust plate 1 and differences in the accuracy of tools, by applying a flattening press after the above pressing, a dynamic pressure-type thrust bearing unit having still higher accuracy can be realized.

As a flattening press, a flat surface-pushing press wherein the thrust plate 1 is sandwiched between a flat surface punch 4 and a flat surface die 4a as shown in FIG. 5(a), a waffle-die press wherein the thrust plate 1 is sandwiched between a waffle-die punch 5 having stellate projections provided all over the punching surface thereof and a waffle die 5a as shown in FIG. 5(b), a reverse flat surface-striking press wherein the thrust plate 1 is sandwiched between a reverse flat surface punch 6 and a reverse flat surface die 6a which are finished to be flat surface shapes reverse to the curve of a work-piece as shown in FIG. 5(c) and the like can be used. Of these, a single press may be used or a plurality of presses may be used in combination.

In addition, in the above description, a case where the dynamic pressure grooves 2 are formed on one side 1a of the thrust plate 1 has been described by way of example, however, the present invention can also be applied to cases where the dynamic pressure grooves 2 are formed on one side of the thrust flange 7 and on both surfaces thereof.

In addition, stainless steel has been described by way of example as the material for forming the thrust plate 1, however, the present invention is not limited hereto, and a material having hardness of 180 through 340 in terms of Vickers hardness may be used. As such a material, for example, iron, steel, phosphor bronze and the like can be used.

In addition, in the above description, a case where the groove portion 12 of the dynamic pressure grooves 2 is a concave portion and the non-groove portion is a convex portion has been described by way of example, however, the present invention is not limited hereto and the groove portion 12 may be a convex portion and the non-groove portion 13 may be a concave portion.

(Embodiment 2)

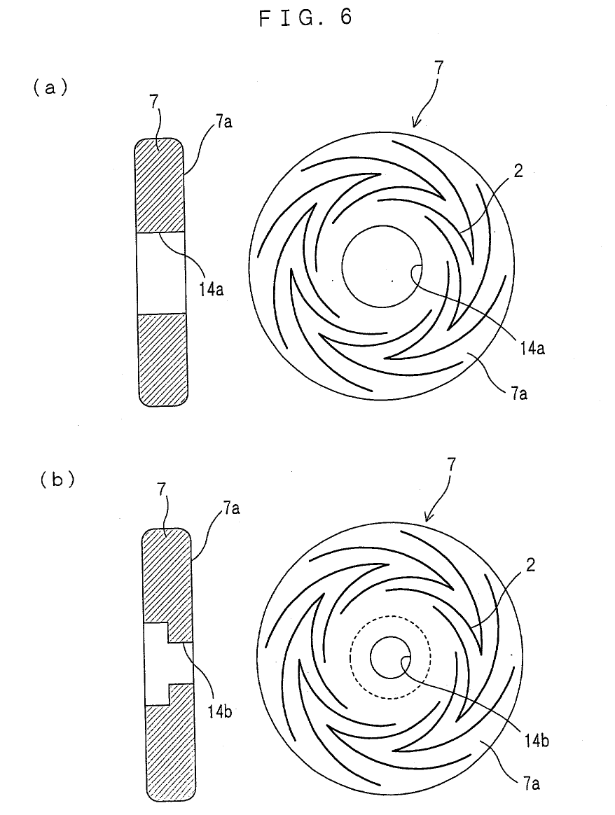

FIG. 6 shows Embodiment 2 of the present invention.

In Embodiment 2, the dynamic pressure grooves 2 are formed on the thrust flange 7 having holes 14a and 14b formed on the central portion thereof, which is a different aspect, however other aspects of the construction are the same as those of the above Embodiment 1.

As shown in FIG. 6(a), on the central portion of the disk-like thrust flange 7, the step-less straight hole 14a for fixing the front end of a shaft portion 11 is formed, and on the outer circumferential portion of the hole 14a of one surface 7a of the thrust flange 7, the dynamic pressure grooves 2 similar to those of the above Embodiment 1 are formed.

In addition, in FIG. 6(b), the stepped hole 14b for fixing the front end of the shaft portion 11 by a screw is formed on the central portion of the thrust flange 7, and similar to the above, the dynamic pressure grooves 2 are formed on the outer circumferential portion of the hole 14b of the surface 7a.

As such, in the case where the dynamic pressure grooves 2 are formed on the thrust flange 7 having the straight hole 14a or the stepped hole 14b formed, since the material for forming the thrust flange 7 flows, due to press working, toward not only the outer circumferential side but also the inner circumferential side, fluidity is still enhanced and accurate dynamic pressure grooves can be easily realized.

Furthermore, the fluidity on the inner circumferential side of the material is slightly inferior to the fluidity on the outer circumferential side, and if the difference in fluidity becomes great, in some cases, flatness of the thrust flange 7 is decreased. In such cases, by processing the front end portion of the coining tool 3 into a convex shape 3a similar to the above and actively pushing out the material to the outer circumferential side, the flatness can be improved.

(Embodiment 3)

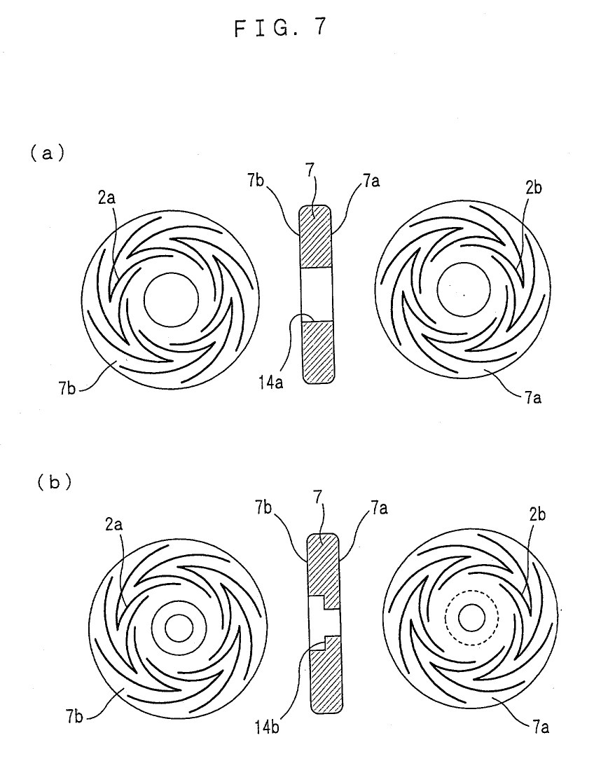

FIG. 7 through FIG. 9 show Embodiment 3 of the present invention.

In Embodiment 3, the dynamic pressure grooves 2 are formed on both surfaces 7a and 7b of the thrust flange 7, which is a different aspect, however, other aspects of the construction are the same as those of the above respective embodiments.

In general, dynamic pressure grooves 2 to be formed on the opposed surfaces of the thrust plate 1 and the thrust flange 7 are referred to as main grooves, and these main grooves are mostly formed for the purpose of generating a floating-up amount. In addition, dynamic pressure grooves to be formed on the side of the shaft body 11 of the thrust flange 7 are referred to as sub-grooves, and these sub-grooves are formed for the purpose of preventing contact between a rotating body and a solid body in the thrust direction which occurs particularly in a case where an excessively floating-up condition occurs under low temperatures and the like.

For example, as shown in FIG. 7(a), if sub-grooves 2b are formed on the surface 7a on the shaft body 11 side of the thrust flange/and main grooves 2a are formed on the surface 7b on the thrust plate 1 side, it becomes unnecessary to form dynamic pressure grooves on the sides of the thrust plate 1 and the sleeve 10, therefore, a reduction in cost can be realized.

In addition, by making the respective pattern shapes of the main grooves 2a and the sub-grooves 25 similar to those of the above respective embodiments, accurate dynamic pressure grooves 2 can be formed.

Furthermore, if press working is simultaneously applied to both surfaces of the thrust flange 7, the material which flows to the outer circumference and inner circumference is captured by groove-shaped portions of the upper and lower tools, and the main grooves 2a and the sub-grooves 2b are formed in a condition where restoration of plastic deformation has become still less. Therefore, the groove depth of the main grooves 2a and the sub-grooves 2b and the height of non-groove portions 13 become approximately the same depth and height between the inner circumferential side and outer circumferential side, the thrust flange 7 having more accurate dynamic pressure grooves 2 formed can be realized.

Also, in the case where press working is simultaneously applied to both surfaces of the thrust flange 7, the positions of the tool for forming the main grooves 2a and the tool for forming the sub-grooves 2b interfere with each other, thereby easily influencing the depth of the grooves, therefore, it is preferable to carry out a press so that the main grooves 2a become phased with the sub-grooves 2b.

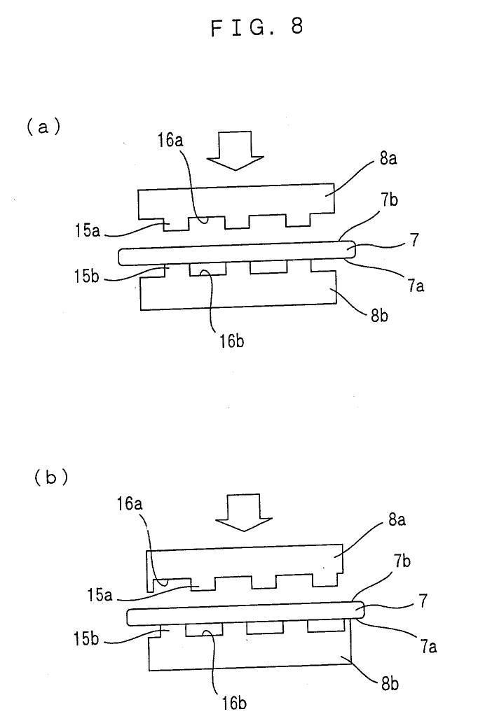

For example, as shown in FIG. 8(a), in a case where a tool 8a forms the main grooves 2a and the tool 8b forms the subgrooves 2b, if press working is performed so that a convex portion 15a of the tool 8a fits a convex portion 15b of the tool 8b and a concave portion 16a of the tool 8a fits a concave portion 16b of the tool 8b, interference between tools is reduced, fluidity of the material can be made uniform, and furthermore, accurate dynamic pressure grooves can be obtained.

Also, as shown in FIG. 8(b), by performing press working so that a convex portion 15a of the tool 8a fits a concave portion 16b of the tool 8b and a concave portion 16a of the tool 8a fits a convex portion 15b of the tool 8b, similar effects can be obtained as well.

Herein, in the above description, the thrust flange having the straight hole 14a formed thereon has been described, however, as shown in FIG. 7(b), a similar description applies to the thrust flange having the stepped hole 14b formed thereon.

Also, as shown in FIG. 7(b), in a case where the dynamic pressure grooves 2 have been formed on both surfaces of the thrust flange having the stepped hole 14b formed thereon, since the shaft body 11 is fixed by screwing, therefore, a high degree of flatness is required on the receiving surface of the shaft body 11.

In addition, in the case where the thrust flange 7 is fixed to the shaft body 11 by a screw (unillustrated), a space is produced between the front end of this screw and the bottom portion of a screw hole of the shaft body 11. If air exists in this space, the air expands due to a change in temperature and pushes oil outside the bearing, thereby causing an oil leak. Since oil is filled in the space produced between the front end of the screw and screw hole bottom portion, it is necessary to form oil paths on the opposed surfaces of the thrust flange/and the shaft body 11.

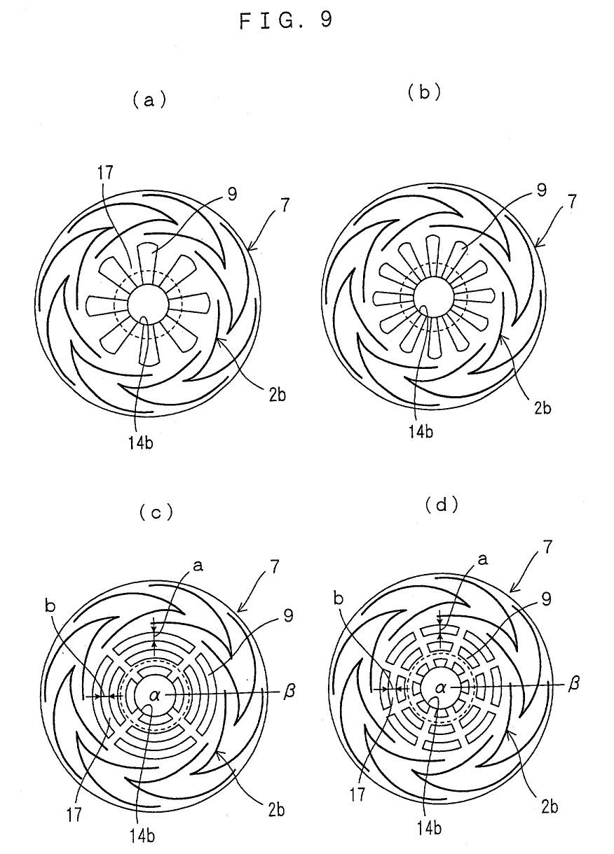

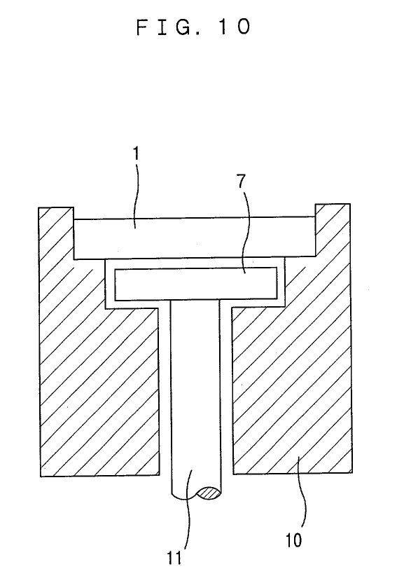

Accordingly, in the thrust flange 7 constructed as shown in FIG. 7(b), as shown in FIG. 9, on the receiving surface for the shaft body 11 around the stepped hole 14b, oil paths (concave portions 17) are formed by providing gaps between annular pressing portions, and also in order to improve flatness thereof, convex portions 9 and the concave portions 17 are formed by press working. In particular, convex portions 9 to be formed on the surface 2b on the shaft body 11 side of the thrust flange 7 have a function to form the oil paths, and convex portions 9 to be formed on the surface 2a on the thrust plate 1 side are utilized as a contact surface when the shaft body 11 is inserted (press-fitted).

However, merely applying press working on the convex portions 9 and the concave portions 17 cannot realize accurate press working as mentioned above, and accurate flatness which is necessary as the contact surface of the shaft body 11 cannot be obtained.

Therefore, in this embodiment, as shown in FIG. 9(a) through FIG. 9(d), it is necessary to improve the flatness by applying press working similar to that of the dynamic pressure grooves 2 in the above (Embodiment 1).

Concretely, as shown in FIG. 9(a) and FIG. 9(b), the convex portions 9 and the concave portions 17, which are formed on the outer circumferential portion of the hole 14b, are radially arranged at even intervals. Namely, the roughly rectangular convex portions which become thicker the closer to the outer circumference are radially arranged at even intervals. These convex portions 9 are arranged at an angle of 45°, and in FIG. 9(b), at an angle of 30°. The width of the convex portions 9 to the concave portions 17 along the circumferential direction is approximately 1:1. By carrying out a press with such a pattern, flatness of the receiving surface for the shaft body 11 is improved.

In addition, as shown in FIG. 9(c) and FIG. 9(d), the convex portions 9 and the concave portions 17 are concentrically arranged on the outer circumferential portion of the hole 14b, and the convex portions 9 of FIG. 9(c) are, respectively, divided at 90°, and the convex portions 9 of FIG. 9(d), at 45°. A press has been carried out with a pattern whereby the width a of the convex portions 9 to the width b of the concave portions 17 along the radius direction [α-β] becomes approximately 1:1. By forming the convex portions 9 and the concave portions 17 with such a pattern, similar effects to the above can be obtained as well.

By employing such a construction, in a case where the shaft body 11 is attached by a method such as screwing, press fit, adhesion, deposition or the like, inclination accuracy can be improved and also oil leaks can be reduced, therefore, a further highly accurate dynamic pressure-type thrust bearing unit can be obtained.

As has been described above, according to the method for manufacturing a dynamic pressure-type thrust bearing unit of the invention, by carrying out a press with a pattern whereby the width of the groove portions to the width of the non-groove portions in the direction of arrangement of the adjacent dynamic pressure-generating grooves becomes approximately 1:1, even with the thrust plate or the thrust flange made of hard metal having hardness of 180 through 340 in terms of Vickers hardness, accurate dynamic pressure-generating grooves can be easily formed by press working, thus a dynamic pressure-type thrust bearing unit which is excellent in abrasion resistance and also has accuracy can be easily realized.

1. A method for manufacturing a dynamic pressure-type thrust bearing unit in which dynamic pressure-generating grooves are formed on at least one surface of opposed surfaces of a thrust flange and a thrust plate, the thrust flange being provided on a front end portion of a shaft body, and the thrust plate being provided, in an opposed relation to the thrust flange, at a side of a rotating body rotatably supported on the shaft body, wherein
a groove-cutting surface for forming thereon the dynamic pressure-generating grooves is pressed with a pattern which produces a width ratio of approximately 1:1 between groove portions and non-groove portions in a direction of arrangement of the adjacent dynamic pressure-generating grooves.

2. A method for manufacturing a dynamic pressure-type thrust bearing unit as set forth in claim 1, wherein
a metal for forming the groove-cutting surface for forming thereon the dynamic pressure-generating grooves is caused to flow from a central portion toward an outer peripheral portion of the surface, and pressed so that an outside diameter of the pattern becomes approximately the same as that of the groove-cutting surface for forming thereon the dynamic pressure-generating grooves.

3. A method for manufacturing a dynamic pressure-type thrust bearing unit as set forth in claim 1, wherein
dynamic pressure-generating grooves are pressed to an outer peripheral portion of a straight hole or a stepped hole formed in the central portion of the groove-cutting surface for forming thereon the dynamic pressure-generating grooves.

4. A method for manufacturing a dynamic pressure-type thrust bearing unit as set forth in claim 1, wherein
dynamic pressure-generating grooves are simultaneously pressed to both surfaces of the thrust flange.

5. A method for manufacturing a dynamic pressure-type thrust bearing unit as set forth in claim 4, wherein
phases of the dynamic pressure-generating grooves to be formed on one surface and the dynamic pressure-generating grooves to be formed on the other surface are adjusted to correspond to each other at the time of pressing.

6. A method for manufacturing a dynamic pressure-type thrust bearing unit as set forth in claim 1, wherein
a shaft body-receiving surface of the thrust flange is pressed with a pattern which forms concave portions and convex portions radially or concentrically arranged, and produces the width ratio of approximately 1:1 between the concave portions and the convex portions, thereby to improve flatness of the shaft body-receiving surface.

7. A method for manufacturing a dynamic pressure-type thrust bearing unit as set forth in claim 1, wherein
after the dynamic pressure-generating grooves have been formed, the thrust flange or the thrust plate is processed with flat-pressing.

8. A dynamic pressure-type thrust bearing unit in which dynamic pressure-generating grooves are formed on at least one surface of opposed surfaces of a thrust flange and a thrust plate, the thrust flange being provided on a front end portion of a shaft body, and the thrust plate being provided, in an opposed relation to the thrust flange, at a side of a rotating body rotatably supported on the shaft body, wherein the dynamic pressure-generating grooves are formed to produce a width ratio of approximately 1:1 between groove portions and non-groove portions in a direction of arrangement of the adjacent dynamic pressure-generating grooves.

9. A method for manufacturing a dynamic pressure-type thrust bearing unit as set forth in any of claim 1 through claim 7, wherein
the groove-cutting surface for forming thereon the dynamic pressure-generating grooves, which is subjected to pressing, has a hardness of 180 through 340 as expressed in Vickers hardness.
